(19) United States
(12) Patent Application Publication
(10) Pub. No.: US 2004/0112413 A1
(43) Pub. Date: Jun. 17, 2004

(54) Piezoelectric transducer for generating ultrasound

(76) Inventors: Johann Brunner, Moensheim (DE); Joachim Straka, Straubenhardt (DE)

Correspondence Address: Flynn Theil, Boutell & Tanis, 2026 Rambling Road, Kalamazoo, MI, 49008-1631, US

(21) Appl. No.: 10/468,686

(22) PCT Filed: Jan. 24, 2002
(86) PCT No.: PCT/EP02/00702

(30) Foreign Application Priority Data
Feb. 21, 2001 (DE) 10109932.0

(51) Int. Cl. B08B 3/12; B08B 7/00; B08B 3/00

(52) U.S. Cl. 134/184; 134/1

(57) ABSTRACT

The invention relates to a piezoelectric transducer for generating ultrasound, in particular for ultrasonic cleaning, comprising a vibration plate for transferring of vibrations onto a fluid, and comprising at least one piezo element for generating ultrasound with a one-piece body made of a piezoelectric material having a first surface and a second surface which are arranged essentially parallel to one another and are provided at least in sections with an electrically conductive coating, whereby the piezo element rests with its second surface on the vibration plate and is connected thereto. The electrically conductive coating of the first surface has according to the invention at least two electrodes which are electrically insulated from one another to facilitate application of an operating voltage, and the electrically conductive coating of the second surface is electrically insulated from the first and the second electrodes, and is arranged at least in sections opposite the first and the second electrodes. Use, for example, for ultrasonic cleaning systems.

The invention relates to a piezoelectric transducer for generating ultrasound, in particular for ultrasonic cleaning, comprising a vibration plate for transferring of vibrations onto a fluid, and comprising at least one piezo element for generating ultrasound with a one-piece body made of a piezoelectric material having a first surface and a second surface which are arranged essentially parallel to one another and are provided at least in sections with an electrically conductive coating, whereby the piezo element rests with its second surface on the vibration plate and is connected thereto.

A piezoelectric transducer is known from U.S. Pat. No. 4,804,007, in which to generate high-frequency ultrasound for ultrasonic cleaning, piezo ceramics are glued in plate form on vibration plates made of quartz glass. Both sides of the piezo ceramics are coated with conductive material, and the coatings are connected to a high-frequency generator through connecting cable. The electrically conductive coating on the underside, namely the side of the piezo ceramics which is glued to the vibration side, must for this purpose be additionally formed by guiding the electrically conductive coating onto an accessible face so that it is accessible for connecting cable. Due to the described design of the piezo ceramics, these represent a plate condenser. When controlling via a high frequency operating voltage, this has the consequence that a reactive current flows through this condenser. The higher the frequency and the larger the surface of the piezo ceramics to be controlled, the greater becomes this current. The high-frequency behavior of the piezo ceramics is disadvantageously influenced by the reactive current. The vibration plate is inserted into a support frame which forms the bottom of a cleaning basin.

The creation of piezoelectric transducers is simplified with the invention and its high-frequency behavior is improved.

According to the invention, a piezoelectric transducer for generating ultrasound is provided for this purpose according to the preamble of claim 1, in which the electrically conductive coating of the first surface has at least two electrodes which are electrically insulated from one another to facilitate application of an operating voltage, and the electrically conductive coating of the second surface is electrically insulated from the first and the second electrodes and is arranged at least in sections opposite the first and the second electrodes.

Since the electrically conductive coating of the second surface is insulated electrically from the first and the second electrodes on the first surface, the piezo ceramics can be contacted exclusively from the side of the first surface on the first and the second electrodes. That is, a guiding of the contact material around a face of the piezo ceramics or onto an accessible face is no longer needed. The connecting cable can be connected to the two electrodes lying on the first surface. A series connection of two piezo elements exists in an electric aspect, which results in an improved high-frequency behavior during generating of ultrasound in ranges of 300 kHz to 3 MHz. In comparison to common piezo elements a reactance capacitance can be reduced to 25%. Since the piezo element has a body made in one piece out of a piezoelectric material, the entire piezo element vibrates at a uniform resonant frequency.

The electrodes arranged on the first surface can have the same size surface, thus achieving an even excitation of the piezoelectric material. Also equally large electric capacitances of the plate condensers can be achieved.

The electrically conductive coating on the second surface can cover same completely. By continuously coating the second surface, the creation of the piezo element is simplified since the coating of the second surface must not be structured. The piezo element can be designed for generating ultrasound in the range of 300 kHz to 3 MHz. A particularly good cleaning action results in this frequency range without damaging the finest structures. The piezoelectric material can be designed plate-shaped. In connection with the special inventive design of the piezo element, a plate form is particularly advantageous. The piezoelectric material can be easily coated as a one-piece plate or disk, and is particularly suited for adhesive securement to a vibration plate to transfer vibrations into a cleaning fluid. The dimensions of the piezo elements can vary from a circular disk form with a diameter of 15 mm, rectangular forms up to square piezo elements with dimensions of 400 mm×400 mm.

The inventive piezoelectric transducer can on the one hand be easily manufactured since the piezo elements can, for example, be adhesively secured to the vibration plate, and the contacts must merely be provided on the side of the piezo element which is remote from the adhesive side. Due to the reduced reactance capacitance of the piezo element, an effective generating of high-frequency ultrasound is possible. The transducer can be designed, for example, as an immersion vibrator for immersion in a cleaning basin.

The vibration plate forms in a further development of the invention a bottom or a sidewall of a cleaning basin.

A structurally simple design is achieved in this manner and problematic joint areas are avoided. This is particularly of importance since sealants can lead to contaminations of process baths.

The vibration plate in a further development of the invention is made of quartz glass.

Since, for example, the bottom of the cleaning basin is formed completely by the vibration plate made of quartz glass, the good vibration-transfer characteristics of quartz glass can be combined with a simple structural design of the cleaning basin with as few joint areas as possible.

The vibration plate in a further development of the invention is made of aluminum, titanium, fine steel or ceramics, in particular Al₂O₃.

These materials guarantee a low-loss vibration transfer onto the cleaning fluid in the cleaning basin and are thereby hardly sensitive with respect to usually used cleaning fluids.

The vibration plate is dimensioned in its thickness, in a further development of the invention, in such a manner that it acts during the resonant frequency of the at least one piezo element as a λ/2 vibrator. The thickness of the vibration plate can also be the multiple of λ/2 during the resonant frequency of the at least one piezo element.

Through such a dimensioning of the thickness of the vibration plate, an effective transfer of the vibrations of the piezo element into the cleaning fluid is achieved.

Several piezo elements and means for the separate control of the individual piezo elements are provided in a further development of the invention.

A high degree of flexibility in the control of the piezo elements is achieved in this manner. The spacial distribution of the ultrasound waves in the cleaning fluid can, for example, be influenced in this manner.

Several piezo elements and means for the simultaneous control of the piezo elements are provided in a further development of the invention in order to generate a vibration through the thickness of and essentially over the entire surface of the vibration plate.

An even distribution of the ultrasound waves in the cleaning fluid can be achieved in this manner during an effective vibration transfer from the piezo elements into the cleaning fluid.

Several piezo elements and means for the successive control of the piezo elements are provided in a further development of the invention in order to stimulate the vibration plate in the form of a wave traveling over the vibration plate.

A sound wave distribution in the cleaning fluid, which sound wave distribution is particularly advantageous for special cleaning tasks, can be achieved with these measures.

Several piezo elements, in a further development of the invention, are arranged in the form of a multi-line grid on the vibration plate.

The arrangement in the form of a multi-line grid assures a good space utilization on the vibration plate and secures an even distribution of the ultrasound waves in the cleaning fluid. The spacings between the individual piezo elements within the grid are thereby advantageously chosen to be very small in comparison to their dimensions lying in the plane of the vibration plate, for example, a spacing between individual piezo elements being below one tenth of its smallest dimension in the plane of the vibration plate.

Further characteristics and advantages of the invention result from the following description of preferred embodiments of the invention in connection with the drawings and the claims. In the drawings:

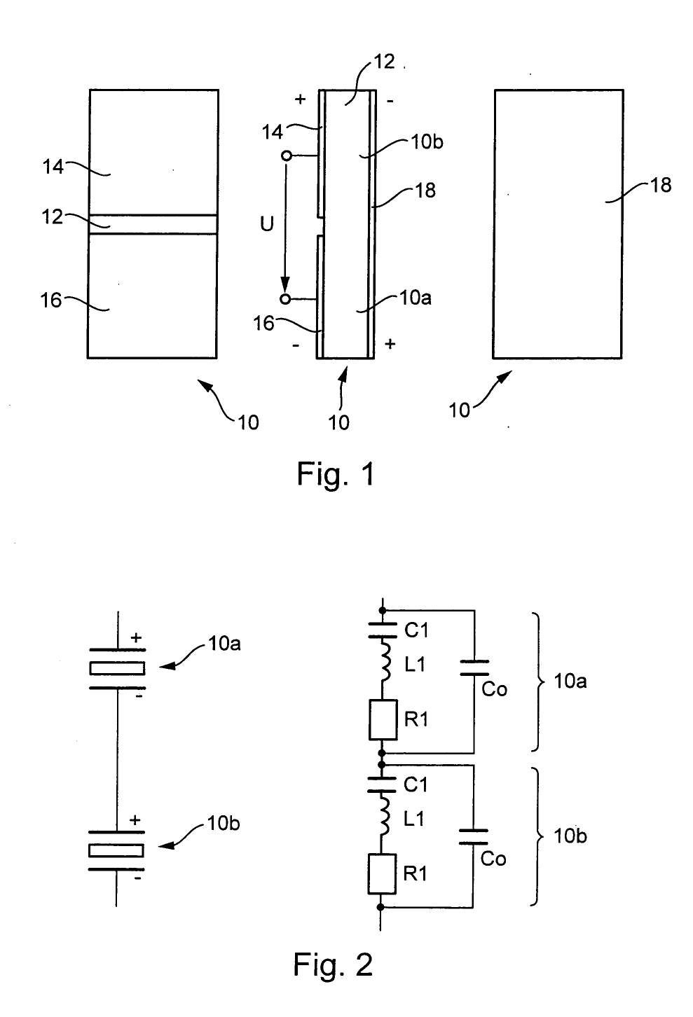

FIG. 1 is a top view, a side view and a bottom view of a piezo element for an inventive transducer according to a preferred embodiment of the invention,

FIG. 2 illustrates two electric replacement circuit diagrams of the piezo element of FIG. 1 in different degrees of abstraction,

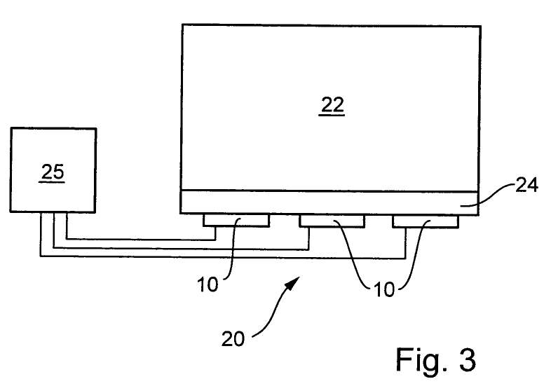

FIG. 3 is a schematic illustration of a piezoelectric transducer according to a preferred embodiment of the invention, and

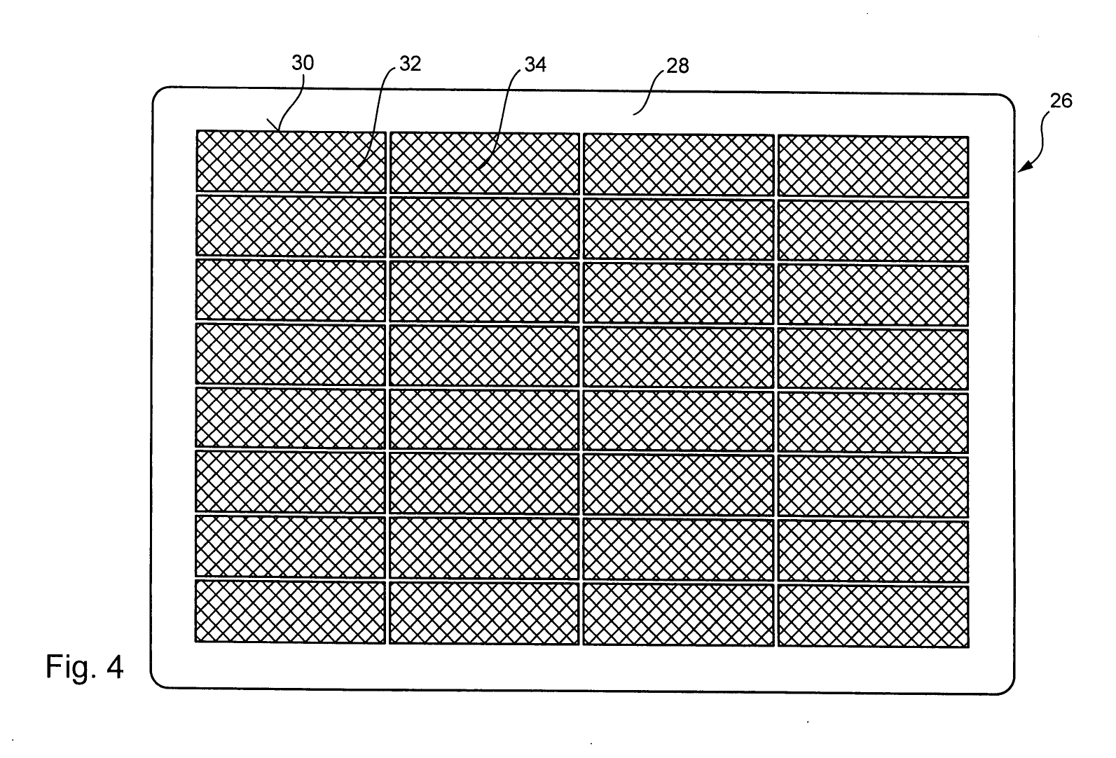

FIG. 4 is a top view of a piezoelectric transducer according to a second preferred embodiment of the invention.

The illustration of FIG. 1 shows a piezo element 10 in various views, which piezo element has a plate-shaped body 12, which consists of piezo ceramics. A first surface of the piezo ceramics 12 is coated with two electrically conductive electrodes 14 and 16 which have the same size surface and are arranged symmetrically on the piezo ceramics. As it is schematically indicated in the side view of FIG. 1, an operating voltage U is applied to the two electrodes 14 and 16.

A second surface, which lies opposite the first surface of the piezo ceramics, has a continuous, electrically conductive coating 18. When an operating voltage, directed corresponding to FIG. 1, is applied to the two electrodes 14 and 16 of the piezo element 10, the half of the piezo ceramics 12, which half is the upper half in FIG. 1, is formatted oppositely to the lower half since the potential of the coating 18 is adjusted to a medium voltage between the potentials of the electrodes 14 and 16. The electrode 14 has, therefore, a higher potential than the coating 18 and the coating 18 has a higher potential than the electrode 16.

The operating voltage U causes both in the upper section 10a and also in the lower section 10b of the piezo ceramics 12 a change in the thickness which, since the potential of the coating 18 adjusts to a medium potential, has the same size in the upper and lower section 10a, 10b. When a high-frequency voltage is applied as the operating voltage U, the piezo ceramics 12 made out of one piece vibrates at a uniform frequency, for example, the resonant frequency of the piezo ceramics 12.

As can be recognized in FIG. 1, the coating 18 must no longer extend around the face of the piezo ceramics 12 onto its first surface. This significantly simplifies the creation of the piezo element 10 and in particular of a transducer through an adhesively secured piezo element 10.

The electric equivalent circuit diagram of the piezo element 10 of FIG. 1, which equivalent circuit diagram is illustrated on the left in FIG. 2, illustrates a series connection of two piezo elements 10a and 10b, whereby the piezo element 10a represents the upper section and the piezo element 10b the lower section of the piezo element 10 illustrated in FIG. 1. This series connection of the sections 10a and 10b results in a clearly improved high-frequency behavior of the piezo element 10. In this manner it is possible to reduce the reactance capacitance of the piezo element 10, in contrast to conventional piezo elements having two-sided contacts, to 25%.

The detailed equivalent circuit diagram illustrated on the right in FIG. 2 illustrates also clearly the series connection of the sections 10a and 10b of the piezo element 10. The condenser Co represents in each case the capacitance of the plate condenser formed by the electrode 14 or 16 and the coating 18. The capacitance C1 represents in each case the reciprocal value of the spring stiffness of the piezo ceramics 12. The inductance L1 represents in each case the inert mass of the piezo ceramics 12 and the resistor R1 represents the internal and outer losses.

Using the equivalent circuit diagram illustrated on the right in FIG. 2, it is possible to determine the electric behavior and a resonant frequency of the piezo element 10.

A piezoelectric transducer 20 can be recognized in the schematic illustration of FIG. 3 and is depicted on the bottom surface of a cleaning basin 22. A cleaning fluid can be filled into the cleaning basin 22, into which cleaning fluid can be transferred ultrasonic vibrations by means of the transducer 20.

The transducer 20 includes a vibration plate 24 which is made, for example, of a quartz glass. Several piezo elements 10 are adhesively secured onto a surface of the vibration plate 14 that faces away from the cleaning basin 22. The piezo elements 10 can be electrically connected to a control device 25 which includes a high-frequency generator. The coating 18 on the piezo elements 10 is, corresponding to the illustration in FIG. 1, adhesively secured to the respective surface of the vibration plate 24 so that the contacting surface of the piezo elements 12 faces away from the cleaning basin 22. The vibration plate 24 is dimensioned in such a manner in its thickness that it acts during the resonant frequency of the piezo elements 10 as a λ/2-vibrator and thus provides for an effective transfer of the ultrasonic vibrations produced by the piezo elements 10 into the cleaning fluid. At least one transducer 10 is in a modified embodiment provided in the area of at least one sidewall of a cleaning basin. The control device 25 is provided for controlling the piezo elements 10.

The illustration of FIG. 3 shows that the vibration plate 24 forms the complete bottom of the cleaning basin 22. The vibration plate 24 must therefore be only sealingly connected to the sidewalls of the cleaning basin 22. This reduces the number of joint areas in the cleaning basin 22.

FIG. 4 illustrates in a top view a piezoelectric transducer 26 according to a further preferred embodiment of the invention. The piezoelectric transducer 26 has a rectangular vibration plate 28 which is provided as the bottom of a cleaning basin. A total of 16 piezo elements 30 are adhesively secured to the vibration plate 28 in the form of a grid forming two columns and eight lines. As is illustrated in FIG. 4, the space available on the vibration plate 28 is utilized at an optimum, and the spacing between the individual piezo elements 30 is, in comparison to their dimensions lying in the drawing plane of FIG. 4, very small and is less than one tenth of the dimension of the shorter side length of the piezo elements 30 extending parallel to the edge of the vibration plate 28. The edge area of the vibration plate 28, where no piezo elements are arranged, is used to arrange the sidewalls of a cleaning basin. Each pair of connection electrodes 32 or 34 can be recognized on the piezo elements 30. The connection electrodes 32 or 34 are separated and isolated from one another by a small space and extend at each of three outer edges to an associated outer edge of an adjacent piezo element 30, respectively. The piezo elements 30 are caused to vibrate by applying an electric voltage through the connection electrodes 32 and 34.

The thickness of the vibration plate 28 is thereby dimensioned so that it amounts to a multiple of λ/2 during the resonant frequency of the piezo elements 30. The wave length in the vibration plate 28 is determined by the sound transmitting speed of the vibration plate 28 and the excitation frequency of the piezo elements 30 so that the design of the thickness of the vibration plate 28 can be controlled using the resonant frequency of the piezo elements 30.

The individual piezo elements 30 within the grid can thereby be controlled in different ways. It is possible, for example, to simultaneously control all piezo elements 30 so that the vibration plate 28 carries out an equal phase vibration throughout the thickness and essentially over its entire surface. Moreover, the piezo elements can be controlled one after the other in such a manner that a thickness vibration in the form of a wave travels over the vibration plate 28.

Finally it is possible to separately control the individual piezo elements 30 in order to achieve for a given case a special distribution of the ultrasonic waves in the cleaning basin. It is possible to switch the high-frequency power output of a generator in an adjustable time cycle of 2 to 8 seconds to the individual piezo elements 30 to effect a successive or separate control of the individual piezo elements 30. The generator can in each case be shortly turned off to effect a powerless switching.

1. A piezoelectric transducer for generating ultrasound, in particular for effecting ultrasonic cleaning, comprising a vibration plate (24; 28) for transferring vibrations onto a fluid, and comprising at least one piezo element (10; 30) for generating ultrasound with a one-piece body (12) made of a piezoelectric material having a first surface and a second surface which are essentially arranged parallel to one another, and are provided at least in sections with an electrically conductive coating, whereby the piezo element (10; 30) rests with its second surface on the vibration plate (24; 28) and is connected to said vibration plate for the transfer of vibrations, wherein the electrically conductive coating of the first surface has at least two electrodes (14, 16; 32, 34) which are electrically insulated from one another to facilitate application of an operating voltage, the electrically conductive coating (18) of the second surface is electrically insulated from the first and the second electrodes and is arranged at least in sections opposite the first and the second electrodes (14, 16; 32, 34).

2. The piezoelectric transducer according to claim 1, wherein the vibration plate (24; 28) forms a bottom or a sidewall of a cleaning basin (22).

3. The piezoelectric transducer according to claim 2, wherein the vibration plate (24; 28) consists of a quartz glass.

4. The piezoelectric transducer according to claim 1 or 2, wherein the vibration plate (24; 28) consists of aluminum, titanium, fine steel or ceramics, in particular Al₂O₃.

5. The piezoelectric transducer according to one of the above claims, wherein the vibration plate (24; 28) is dimensioned in its thickness in such a manner that it acts as a λ/2 vibrator during the resonant frequency of the at least one piezo element (10; 30).

6. The piezoelectric transducer according to one of the above claims, wherein the thickness of the vibration plate (24; 28) is a multiple of λ/2 during the resonant frequency of the at least one piezo element (10; 30).

7. The piezoelectric transducer according to one of the above claims, wherein several piezo elements (10; 30) and means (25) are provided for the separate control of the individual piezo elements (10; 30).

8. The piezoelectric transducer according to one of the above claims, wherein several piezo elements (10; 30) and means (25) are provided for the simultaneous control of the piezo elements (10) in order to generate a vibration through the thickness of and essentially over the entire surface of the vibration plate (24; 28).

9. The piezoelectric transducer according to one of the above claims, wherein several piezo elements (10; 30) and means (25) are provided for the successive control of the piezo elements (10; 30) in order to stimulate the vibration plate (24; 28) in form of a wave traveling over the vibration plate (24; 28).

10. The piezoelectric transducer according to one of the above claims, wherein several piezo elements (10; 30) are arranged in the form of a multi-line grid on the vibration plate (24; 28).
